(19) United States
(12) Patent Application Publication
(10) Pub. No.: US 2025/0232451 A1
(43) Pub. Date: Jul. 17, 2025

(54) DETECTING MOVING OBJECTS

(71) Applicant: QUALCOMM Incorporated, San Diego, CA (US)

(72) Inventors: Ming-Yuan YU, Austin, TX (US); Varun RAVI KUMAR, San Diego, CA (US); Senthil Kumar YOGAMANI, Headford (IE)

(21) Appl. No.: 18/410,138

(22) Filed: Jan. 11, 2024

(51) Int. Cl. G06T 7/20; B60W 50/14; G06V 10/44; G06V 10/764; G06V 20/58

(52) U.S. Cl. CPC G06T 7/20; B60W 50/14; G06V 10/44; G06V 10/764; G06V 20/58; G06V 2201/07

(57) ABSTRACT

Systems and techniques are described herein for detecting objects. For instance, a method for detecting objects is provided. The method may include obtaining image data representative of a scene and point-cloud data representative of the scene; processing the image data and the point-cloud data using a machine-learning model, wherein the machine-learning model is trained using at least one loss function to detect moving objects represented by image data and point-cloud data, the at least one loss function being based on odometry data and at least one of training image-data features or training point-cloud-data features; and obtaining, from the machine-learning model, indications of one or more objects that are moving in the scene.

### TECHNICAL FIELD

The present disclosure generally relates to detecting moving objects. For example, aspects of the present disclosure include systems and techniques for detecting moving objects using sensors that are also moving.

### BACKGROUND

Detecting moving objects in crowded environments (e.g., urban environments) is challenging, for example, due to objects being occluded, the number of moving people and/or vehicles within the crowded environment, and complex interactions between the moving people and/or vehicles. Moving-object detection can be further complicated when a source of visual information representative of the scene is moving. Moving-object detection is an important precursor to motion prediction, which enables downstream tasks like planning safe navigation for autonomous vehicles.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for detecting objects. According to at least one example, a method is provided for detecting objects. The method includes: obtaining image data representative of a scene and point-cloud data representative of the scene; processing the image data and the point-cloud data using a machine-learning model, wherein the machine-learning model is trained using at least one loss function to detect moving objects represented by image data and point-cloud data, the at least one loss function being based on odometry data and at least one of training image-data features or training point-cloud-data features; and obtaining, from the machine-learning model, indications of one or more objects that are moving in the scene.

In another example, an apparatus for detecting objects is provided that includes at least one memory and at least one processor (e.g., configured in circuitry) coupled to the at least one memory. The at least one processor configured to: obtain image data representative of a scene and point-cloud data representative of the scene; process the image data and the point-cloud data using a machine-learning model, wherein the machine-learning model is trained using at least one loss function to detect moving objects represented by image data and point-cloud data, the at least one loss function being based on odometry data and at least one of training image-data features or training point-cloud-data features; and obtain, from the machine-learning model, indications of one or more objects that are moving in the scene.

In another example, a non-transitory computer-readable medium is provided that has stored thereon instructions that, when executed by one or more processors, cause the one or more processors to: obtain image data representative of a scene and point-cloud data representative of the scene; process the image data and the point-cloud data using a machine-learning model, wherein the machine-learning model is trained using at least one loss function to detect moving objects represented by image data and point-cloud data, the at least one loss function being based on odometry data and at least one of training image-data features or training point-cloud-data features; and obtain, from the machine-learning model, indications of one or more objects that are moving in the scene.

In another example, an apparatus for detecting objects is provided. The apparatus includes: means for obtaining image data representative of a scene and point-cloud data representative of the scene; means for processing the image data and the point-cloud data using a machine-learning model, wherein the machine-learning model is trained using at least one loss function to detect moving objects represented by image data and point-cloud data, the at least one loss function being based on odometry data and at least one of training image-data features or training point-cloud-data features; and means for obtaining, from the machine-learning model, indications of one or more objects that are moving in the scene.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1A is a block diagram illustrating a scene from a stationary frame of reference with velocities of objects in the scene illustrated as arrows;

FIG. 1B is a block diagram illustrating the scene of FIG. 1A from a moving frame of reference with velocities of objects in the scene illustrated as arrows;

FIG. 2 is a block diagram illustrating an example system that may generate bird's-eye-view (BEV) image features based on images, according to various aspects of the present disclosure;

FIG. 3 is a block diagram illustrating an example system that may generate bird's-eye-view (BEV) point-cloud features based on point clouds, according to various aspects of the present disclosure;

FIG. 4 is a block diagram illustrating an example system that may generate classified scene data based on BEV image features and BEV point-cloud features, according to various aspects of the present disclosure;

FIG. 5 is a block diagram illustrating an example system that may generate detect moving objects, according to various aspects of the present disclosure;

FIG. 6 is a block diagram illustrating an example system that may train an example system to detect moving objects, according to various aspects of the present disclosure;

FIG. 7 is a block diagram illustrating an example system that may detect moving objects according to various aspects of the present disclosure;

FIG. 8 is a flow diagram illustrating a process for detecting moving objects, in accordance with aspects of the present disclosure;

FIG. 9 is a block diagram illustrating an example of a deep learning neural network that can be used to perform various tasks, according to some aspects of the disclosed technology;

FIG. 10 is a block diagram illustrating an example of a convolutional neural network (CNN), according to various aspects of the present disclosure; and

FIG. 11 is a block diagram of an example transformer that may be used to perform various operations described herein, according to various aspects of the present disclosure;

FIG. 12 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As mentioned above, moving-object detection may be an important precursor to motion prediction, which enables downstream tasks like planning safe navigation for autonomous vehicles and/or semi-autonomous vehicles. Early fusion is one approach to moving-object detection. Early fusion combines multiple point clouds over time. However, early fusion has high memory costs, in other words, early fusion uses a relatively large amount of memory when performing moving-object detection.

Systems, apparatuses, methods (also referred to as processes), and computer-readable media (collectively referred to herein as “systems and techniques”) are described herein for detecting moving objects. The systems and techniques described herein may leverage odometry data (which may be referred to as “ego-motion”) along with visual data, for example, image data (e.g., from a camera) and/or point-cloud data (e.g., from a light detection and ranging (LIDAR) system). For example, the systems and techniques may perform moving-object detection efficiently by utilizing odometry information in addition to visual data to make determinations about moving objects. The systems and techniques may employ a multi-modal approach using odometry data and visual data (e.g., image data and/or point-cloud data) to help distinguish ego-motion versus object motion to enable robust segmentation.

In the present disclosure, the term “ego” may be used to refer to a system or device that is determining the movement status of other objects in a scene based on sensor data obtained by the system or device. Additionally, in the present disclosure, the term “odometry” may refer to motion data of an ego system or device. For example, an “ego vehicle” may include cameras, a LIDAR system, and an odometry system. The ego vehicle may capture images of the scene and generate LIDAR point clouds representative of the scene. The ego vehicle may further determine odometry data related to the ego vehicle. The ego vehicle may determine which other objects in the scene are moving based on the images, the point clouds, and the odometry data.

Odometry embeds motion-consistency information. For example, odometry techniques, which may be used in an autonomous or semi-autonomous vehicle, may generate six degree of freedom (6DoF) data. 6DoF data my include data describing translations according to three perpendicular degrees of freedom, or axes, for example, an x-axis, a y-axis, and a z-axis. Further, 6DoF data may include data describing rotations according to three perpendicular degrees of freedom, for example, roll, pitch, and yaw. Odometry techniques may use, as examples, commercially-available global-positioning system (GPS) techniques and/or algorithms such as visual odometry and iterative closest point (ICP).

The motion of static objects (e.g., buildings, trees, parked cars, traffic signs, etc.), relative to the ego vehicle may be substantially consistent over time. For example, as an ego vehicle moves at a constant velocity through a scene, static objects in the scene should have a constant velocity relative to the ego vehicle. Further, the magnitude of the velocity of static objects should be consistent with the odometry of the system tracking the static objects. For example, as an ego vehicle moves at a given velocity through a scene, static objects in the scene should have a relative velocity that has the same magnitude as the given velocity of the ego vehicle. The direction of the relative velocity of the static objects should be the opposite of the direction of the velocity of ego vehicle.

In contrast, dynamic objects (e.g., moving vehicles or people) may exhibit different motional characteristics (e.g., faster, slower, and/or different directions) and will have velocities that may not be consistent over time. Further, the magnitude of the velocity of dynamic objects may not match the magnitude of the movement of the ego vehicle.

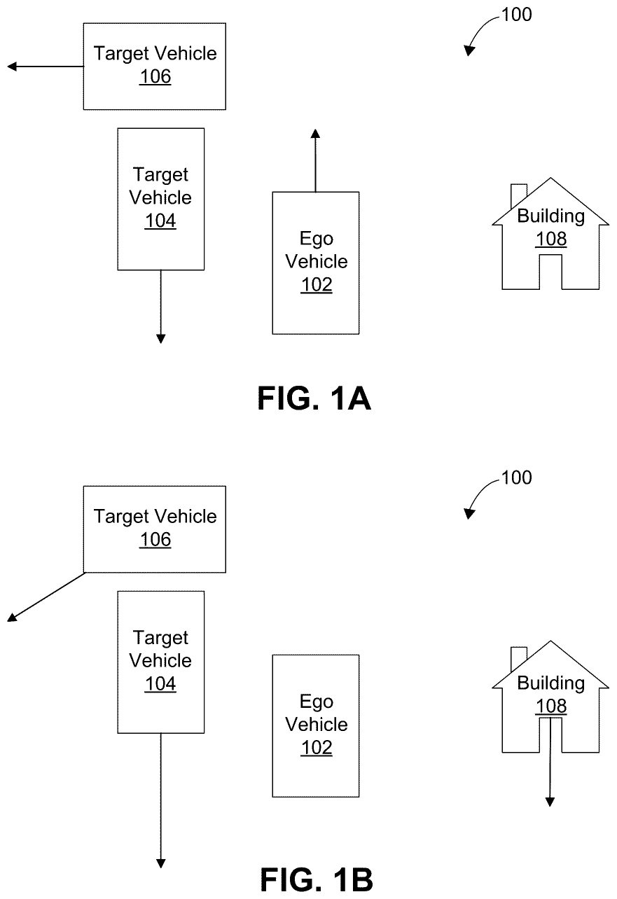

For example, FIG. 1A is a block diagram illustrating a scene 100 in which an ego vehicle 102 moves proximate to a target vehicle 104, a target vehicle 106, and a building 108. FIG. 1A is illustrated from a stationary frame of reference with velocities of ego vehicle 102, target vehicle 104, and target vehicle 106 illustrated as arrows. FIG. 1B is a block diagram illustrating scene 100 from a moving frame of reference, for example, the frame of reference of ego vehicle 102. In FIG. 1B, ego vehicle 102 appears stationary because FIG. 1B is illustrated from the frame of reference of ego vehicle 102. In contrast, target vehicle 104 is illustrated with a velocity that is twice as long in FIG. 1B than in FIG. 1A illustrating that from the frame of reference of ego vehicle 102, target vehicle 104 is moving down twice as fast as target vehicle 104 moved down in FIG. 1A. Target vehicle 106 is illustrated in FIG. 1B moving to the side and downward based on the moving frame of reference of FIG. 1B. Further, building 108 is illustrated as moving down in FIG. 1B based on the moving frame of reference of FIG. 1B. It is notable that in FIG. 1B, the downward velocity of building 108 matches the upward velocity of ego vehicle 102 in FIG. 1A.

Motion consistency of objects may be used to determine whether objects are moving or stationary. In the present disclosure, the term “motion consistency” may refer to whether, or to what degree, a velocity of an object changes over time (e.g., between a first pair of image frames and a next pair of image frames and/or between a first pair of point clouds and a next pair of point clouds). One example technique for determining motion consistency includes a comparison of magnitudes of velocities of objects with the magnitude of the velocity of an ego system or device that captured the visual representations of the objects. A comparison of magnitudes of velocities may be used to determine whether the objects are moving or stationary. In the present disclosure, a comparison of magnitudes of velocities of objects with the magnitude of the velocity of an ego system or device may be referred to as a “magnitude-of-motion comparison.”

Given visual data (e.g., image data captured by a camera and/or point clouds generated by a LIDAR system) and odometry data, the systems and techniques may formulate moving-object detection as a binary classification problem—for example, finding outliers (e.g., pixels, 3D points, or voxels) that travel at significant different velocities from time to time (e.g., lacking motion consistency). Additionally or alternatively, the systems and techniques may use a comparison of magnitudes of velocity (e.g., a magnitude-of-motion comparison) as a criteria for moving-object detection.

Additionally or alternatively, in some aspects, the systems and techniques may include a machine-learning model that is trained based on motion consistency and/or magnitude-of-motion comparisons. For example, some systems and techniques may include a machine-learning model trained using a loss function that is based on motion consistency and/or magnitude-of-motion comparisons.

The systems and techniques may detect moving objects more accurately, in more situations (e.g., in crowded environments), and/or using less computational resources (e.g., power and/or computing time) than other moving-object-detection techniques. For example, the systems and techniques may use less memory to detect objects than techniques relying on early fusion. Additionally or alternatively, the systems and techniques may detect objects based on input data that is cheaper and/or easier to obtain than the input data used by other object-detection techniques. For example, odometry data (which may be used as input data by the systems and techniques) can be obtained cheaply and easily, (e.g., from odometers, which are already presented on modern cars, and/or six degree of freedom (6-DoF) inertial measurement units (IMUs), which are cheap).

Various aspects of the application will be described with respect to the figures below.

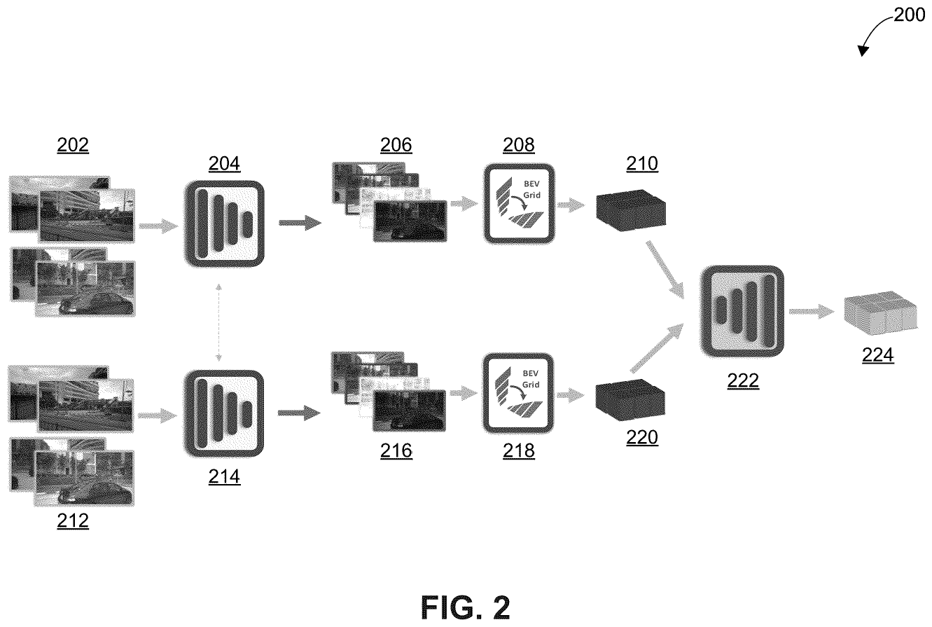

FIG. 2 is a block diagram illustrating an example system 200 that may generate bird's-eye-view (BEV) image features 224 based on images 202 and/or images 212, according to various aspects of the present disclosure. In general, system 200 may obtain images 202 and images 212, encode images 202 as image features 206 (using a feature extractor 204), encode images 212 as image features 216 (using a feature extractor 214), project image features 206 into a BEV space (using a projector 208) to generate BEV image features 210, project image features 216 into a BEV space (using a projector 218) to generate BEV image features 220, and combine BEV image features 210 and BEV image features 220 (using an attention network 222) to generate BEV image features 224.

Images 202 and images 212 may be images captured at an ego system or device (e.g., at an ego vehicle). Images 202 and images 212 may be captured by a camera of the ego system or device. Images 202 and images 212 may be captured at different times. For example, images 202 may be captured at a first time and images 212 may be captured at a second time. In some aspects, a camera may capture images sequentially (e.g., at a frame-capture rate, such as 30 frames per second (fps)). Images 202 may be one of such frames and images 212 may be a subsequent frame (e.g., an immediately subsequent frame).

Feature extractor 204 and feature extractor 214 may be, or may include, one or more machine-learning models (e.g., convolutional neural networks) trained to generate features based on images. For example, feature extractor 204 and feature extractor 214 may be the same machine-learning model operating first on images 202 and second on images 212. Alternatively, system 200 may include two or more machine-learning models for generating features based on images. In any case, feature extractor 204 may share weights determined when encoding images 202 with feature extractor 214 and feature extractor 214 may use the shared weights when encoding images 212.

Projector 208 may project images 202 from a perspective view (e.g., related to a perspective of a camera that captured images 202) into a BEV to generate BEV image features 210. Projector 218 may project images 212 from a perspective view (e.g., related to a perspective of a camera that captured images 212) into a BEV to generate BEV image features 220. Similar to feature extractor 204 and feature extractor 214, projector 208 and projector 218 may be, or may include, one or more projectors.

Attention network 222 may combine BEV image features 210 and BEV image features 220 to generate BEV image features 224. attention network 222 may be, or may include, a machine-learning model trained to combine BEV features. attention network 222 may be, or may include, an attention network, such as a transformer. attention network 222 may operate on BEV image features 210, which may be based on images 202 captured at a first time, and BEV image features 220, which may be based on images 212 captured at a second time. Thus, attention network 222 may be considered a temporal attention network.

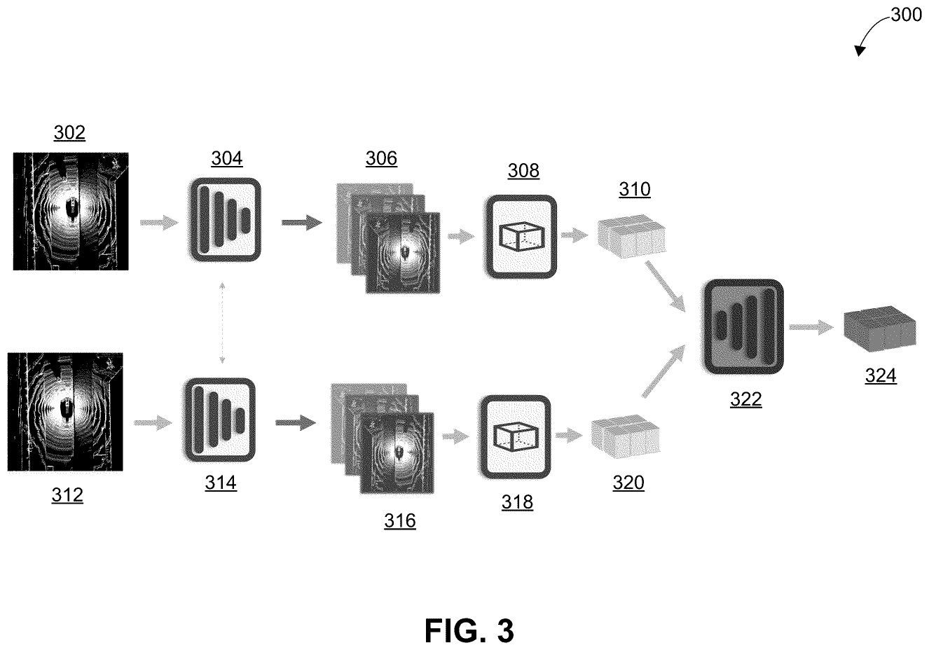

FIG. 3 is a block diagram illustrating an example system 300 that may generate bird's-eye-view (BEV) point-cloud features 324 based on point cloud 302 and/or point cloud 312, according to various aspects of the present disclosure. In general, system 300 may obtain point cloud 302 and point cloud 312, encode point cloud 302 as point-cloud features 306 (using a feature extractor 304), encode point cloud 312 as point-cloud features 316 (using a feature extractor 314), flatten point-cloud features 306 into a BEV space (using a flattener 308) to generate BEV point-cloud features 310, flatten point-cloud features 316 into a BEV space (using a flattener 318) to generate BEV point-cloud features 320, and combine BEV point-cloud features 310 and BEV point-cloud features 320 (using an attention network 322) to generate BEV point-cloud features 324.

Point cloud 302 and point cloud 312 may be point clouds based on measurements taken at an ego system or device (e.g., at an ego vehicle). For example, point cloud 302 and point cloud 312 may be generated based on light detection and ranging (LIDAR) data captured by a LIDAR system of the ego system or device. Point cloud 302 and point cloud 312 may be based on measurements taken at different times. For example, point cloud 302 may be based on measurements taken at a first time and point cloud 312 may be based on measurements taken at a second time. In some aspects, a LIDAR system may make measurements and/or generate point clouds sequentially (e.g., at a LIDAR-capture rate, such as 30 captures per second). Point cloud 302 may be one of such point clouds and images 212 may be a subsequent point cloud (e.g., an immediately subsequent point cloud).

Feature extractor 304 and feature extractor 314 may be, or may include, one or more machine-learning models (e.g., convolutional neural networks) trained to generate features based on point clouds. For example, feature extractor 304 and feature extractor 314 may be the same machine-learning model operating first on point cloud 302 and second on point cloud 312. Alternatively, system 300 may include two or more machine-learning models for generating features based on point clouds. In any case, feature extractor 304 may share weights determined when encoding point cloud 302 with feature extractor 314 and feature extractor 314 may use the shared weights when encoding point cloud 312.

Flattener 308 may flatten point-cloud features 306 from being three-dimensional (e.g., based on point cloud 302) into a BEV to generate BEV point-cloud features 310. Flattener 318 may flatten point-cloud features 316 from being three-dimensional (e.g., based on point cloud 312) into a BEV to generate BEV point-cloud features 320. Similar to feature extractor 304 and feature extractor 314, flattener 308 and flattener 318 may be, or may include, one or more flatteners.

Attention network 322 may combine BEV point-cloud features 310 and BEV point-cloud features 320 to generate BEV point-cloud features 324. attention network 322 may be, or may include, a machine-learning model trained to combine BEV features. attention network 322 may be, or may include, an attention network, such as a transformer. attention network 322 may operate on BEV point-cloud features 310, which may be based on point cloud 302 which may be based on measurements taken at a first time, and BEV point-cloud features 320, which may be based on point cloud 312 which may be based on measurements taken at a second time. Thus, attention network 322 may be considered a temporal attention network.

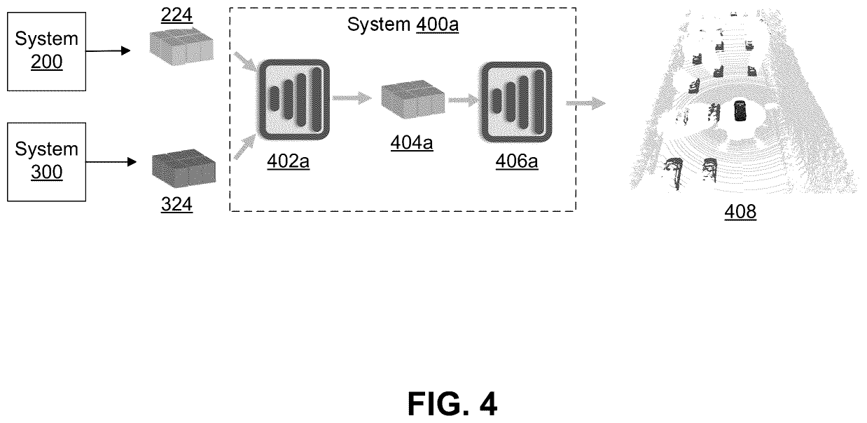

FIG. 4 is a block diagram illustrating an example system 400a that may generate classified scene data 408 based on BEV image features 224 and BEV point-cloud features 324, according to various aspects of the present disclosure. In general, system 400a may obtain BEV image features 224 (e.g., from system 200 of FIG. 1) and BEV point-cloud features 324 (e.g., from system 300 of FIG. 3), combine BEV image features 224 and BEV point-cloud features 324 (using an attention network 402a) to generate fused features 404a, and generate classified scene data 408 based on fused features 404a (using a classifier 406a).

Attention network 402a may combine BEV image features 224 and BEV point-cloud features 324 to generate fused features 404a. Attention network 402a may be, or may include, one or more machine-learning models trained to combine BEV image features and BEV point-cloud features. Attention network 402a may be, or may include, an attention network, such as a transformer. Attention network 402a may operate on BEV image features 224 (which may be based on a first mode, such as, images) and BEV point-cloud features 324 (which may be based on a second mode, such as, point clouds). Thus, attention network 402a may be considered a cross-modal attention transformer.

Classifier 406a may generate classified scene data 408 based on fused features 404a. Classifier 406a may be, or may include, a machine-learning model trained to determine segmented 3D information based in BEV features. Classifier 406a may be trained to classify point in a BEV feature space into classes. In some aspects, classifier 406a may be trained to classify points of the BEV feature space into one of three classes, for example, moving, movable, and stationary. For example, classifier 406a may classify points of the BEV feature space that represent a car that is moving as moving, classifier 406a may classify points of the BEV feature space that represent a car that is parked (e.g., not presently moving) as movable, and classifier 406a may classify points of the BEV feature space that represent a tree as stationary.

Classified scene data 408 is illustrated as a visual representation of points of a BEV of a scene. In the visual representation, black indicates points classified as moving, gray indicates points classified as stationary, and the black points at the center represent an ego vehicle (e.g., the ego vehicle that captured images 202 and images 212 of FIG. 2 and that measured returns to generate point cloud 302 and point cloud 312 of FIG. 3). Classified scene data 408 includes classifications for individual points of the scene.

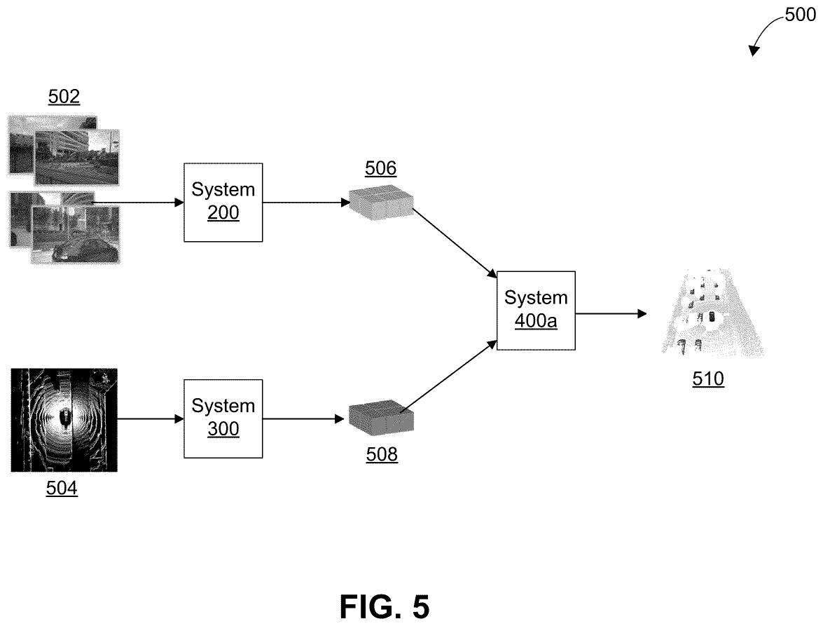

FIG. 5 is a block diagram illustrating an example system 500 that may generate detect moving objects, according to various aspects of the present disclosure. System 500 may include system 200 of FIG. 2, system 300 of FIG. 3, and system 400a of FIG. 4. System 200 may generate BEV image features 506 based on images 502 in the same way that system 200 generates BEV image features 224 based on images 202 and images 212. System 300 may generate BEV point-cloud features 508 based on point cloud 504 in the same way that system 300 generates BEV point-cloud features 324 based on point cloud 302 and point cloud 312. System 400a may generate classified scene data 510 based on BEV image features 506 and BEV point-cloud features 508 in the same way that system 400a generates classified scene data 408 based on BEV image features 224 and BEV point-cloud features 324.

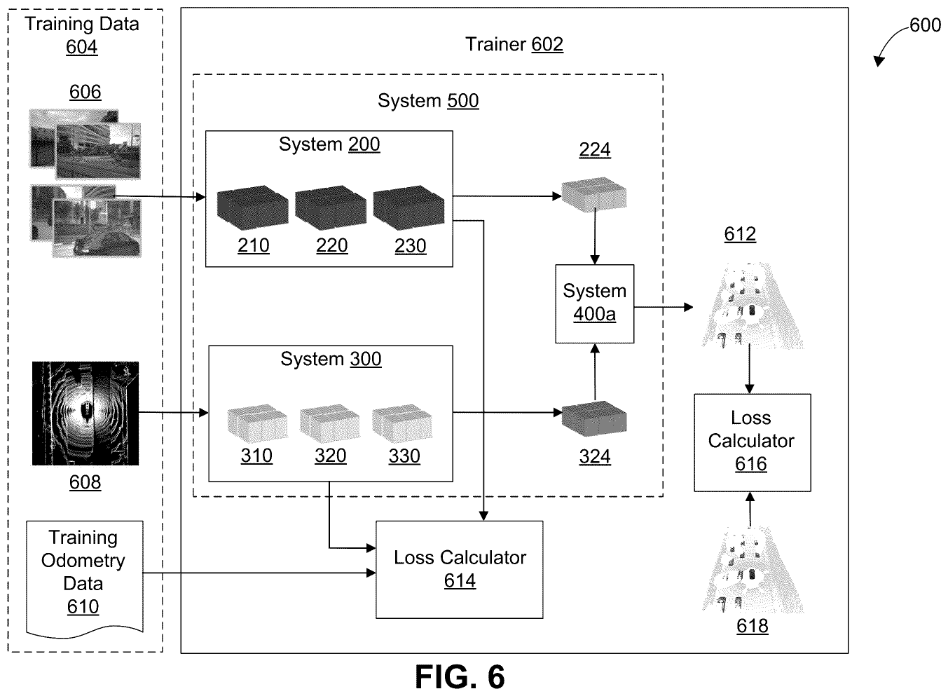

System 500 may be trained based on motion consistency and/or magnitude-of-motion comparisons. For example, the machine-learning models of system 200, system 300, and/or system 400a may be trained, (e.g., in an end-to-end training process) based on motion consistency and/or magnitude-of-motion comparisons. Additional detail regarding the training of system 500 is provided with regard to FIG. 6.

FIG. 6 is a block diagram illustrating an example system 600 that may train an example system (e.g., system 500) to detect moving objects, according to various aspects of the present disclosure. For example, system 600 includes a trainer 602 that may train system 500 of FIG. 5 to generate classified scene data 612 through an iterative back-propagation training process.

For example, in an iteration of the training process, trainer 602 may provide training data 604 (e.g., including a set of training images 606 and a training point cloud 608) to system 500. System 500 may generate classified scene data 612 based on the provided training data 604. Loss calculator 616 of trainer 602 may compare the generated classified scene data 612 with ground-truth data 618 according to a loss function to determine a loss, then adjust parameters (e.g., weights) of system 500 to improve the performance of system 500 for further iterations. Because trainer 602 uses ground-truth data 618, trainer 602 can be considered as implementing supervised training. Because system 500 is trained as a whole (e.g., based on a comparison between an output of system 500—classified scene data 612), trainer 602 can be considered as implementing end-to-end training of system 500.

Training data 604 may be, or may include, a corpus of training data including a number of sets of training images 606, training point clouds 608, and training odometry data 610. Each of the sets of training images 606, training point clouds 608, and training odometry data 610 may be related. For example, a set of training images 606, a training point cloud 608 and training odometry data 610 may include a training images 606 from various cameras of an ego vehicle capture at a given time, a training point cloud 608 generated based on reflections measured at the given time, and training odometry data 610 describing motion of the ego vehicle at the given time. Further, some of the sets of data may be related to others of the sets of data (e.g., some of the sets of data may be from sequential time). For example, a second set of training images 606, a training point cloud 608 and training odometry data 610 may include a training images 606 from the various cameras of the ego vehicle capture at a second time (e.g., less than a second after the given time), a training point cloud 608 generated based on reflections measured at the second time, and training odometry data 610 describing motion of the ego vehicle at the second time. For instance, training data 604 may include sequential frames of image data (e.g., of a video), point clouds generated based on reflections measured at sequential times, and odometry data measured and/or calculated at sequential times.

Training image 606 may include sets of images from any number of cameras of an ego device or system (e.g., an ego vehicle). Training point cloud 608 may be generated based on the timing of reflections measured by a point-cloud system. For example, training point cloud 608 may be generated by a light detection and ranging (LIDAR) system or a radio detection and ranging (RADAR) system.

Training odometry data 610 may be, or may include, data indicative of a pose of a system which captured training image 606 and measured reflections on which training point cloud 608 are based. For example, training odometry data 610 may indicate a pose of an ego vehicle. Training odometry data 610 may describe the pose according to six degrees of freedom (DoF) including three translational degrees of freedom according to three perpendicular axes (for example, an x-axis, a y-axis, and a z-axis) and three rotational degrees of freedom according to three perpendicular degrees of freedom (for example, roll, pitch, and yaw). Training odometry data 610 may be determined, for example, according to commercially-available global-positioning system (GPS) techniques and/or algorithms such as visual odometry and iterative closest point (ICP).

Ground-truth data 618 may relate to training data 604. For example, ground-truth data 618 may include indications of objects in scenes represented by training images 606 and training point cloud 608 that are moving, movable, or stationary. For instance, for a given set of training images 606, a training point cloud 608 (both representative of a scene at a given time) and training odometry data 610 (describing a pose of an ego vehicle at the given time), ground-truth data 618 may include indications of motion status of objects in the scene at the given time.

Training data 604 may include data captured by a system or device (e.g., an ego vehicle). Further, ground-truth data 618 may be generated based on the captured data. Additionally or alternatively, training data 604 may include simulated data and ground-truth data 618 may include simulated data based on the simulated training data.

As described above, trainer 602 may use losses calculated by loss calculator 616 to train system 500 through an iterative back-propagation training process by comparing classified scene data 612 to ground-truth data 618. Additionally, trainer 602 may train system 500 according to motion consistency. For example, trainer 602 may train system 500 to detect moving objects based on whether objects move consistently. For instance, an ego vehicle may move through a scene with a constant velocity (or substantially constant over when considered relative to a frame capture rate of a camera and/or rate of point-cloud generation of a point-cloud system). As the ego vehicle moves through the scene, the relative velocity of stationary objects in the scene is based on the movement of the ego vehicle (e.g., the relative velocity of stationary objects may be the opposite of the absolute velocity of the ego vehicle). In contrast, moving objects may move independent of the ego vehicle and may thus exhibit motion that is not consistent with the motion of the ego vehicle. Trainer 602 may train system 500 to detect moving objects based on whether the objects move consistently over time.

The magnitude of odometry (e.g., ego motion) between timestamp k and k+1 may be denoted as ∥odomₖ^{k+1}∥. The difference of the extracted features at timestamp k and k+1 is interpreted as an abstract velocity in the feature space. The units of the odometry may be irrelevant for this application. However, common units like meters may be used to represent translation and degrees can be used to represent rotation. The magnitude of abstract velocity of static objects should be proportional the magnitude of odometry (e.g., ego motion). Thus, a magnitude-of-motion comparison may be used to define a loss that can be used during training to train system 500 according to motion consistency.

For example, the magnitude of motion (e.g., the magnitude of the difference between features at two times) of stationary objects should be consistent with a magnitude of the motion indicated by odometry data. For example, for stationary objects, the magnitude of differences between BEV image features 210 and BEV image features 220 and the magnitude of differences between BEV point-cloud features 310 and BEV point-cloud features 320 may be consistent with a magnitude of the motion indicated by training odometry data 610.

$$\frac{\vert {C}_{k + 1} - {C}_{k} \vert}{\vert {C}_{k} - {C}_{k - 1} \vert} \leq α \frac{\vert {L}_{k + 1} - {L}_{k} \vert}{\vert {L}_{k} - {L}_{k - 1} \vert} = \frac{\vert {odom}_{k}^{k + 1} \vert}{\vert {odom}_{k - 1}^{k} \vert} \qquad Equation 1$$

where C represents image features (e.g., based on images captured by a camera of an ego vehicle);
where L represents point-clouds features (e.g., based on point clouds based on reflections measured at an ego vehicle, such as a LIDAR-based point cloud);
where k represents a times, k+1 represents a subsequent time, and k−1 represents a preceding time; and
where α represents an adaptive motion-consistency threshold.

A motion-consistency threshold may be used to scale motion between image-based features and point-cloud-based features such that motion according to motion between image-based features and point-cloud-based features has a similar magnitude. For example, a motion-consistency threshold may cause the same motion to have the same magnitude when the motion is represented by consecutive image-based features and consecutive point-cloud-based features. The adaptive motion-consistency threshold may be used instead of using a fixed threshold for motion consistency. The adaptive motion-consistency threshold can be dynamically adjusted based on the scene's complexity and the uncertainty in the odometry data. One way to achieve this is by incorporating a confidence measure or uncertainty estimation for odometry data. Where a is a dynamic threshold that depends on the confidence or uncertainty of the odometry data. By adaptively adjusting the adaptive motion-consistency threshold, system 500 can better handle challenging scenarios and improve the accuracy of moving object segmentation.

In some aspects, temporal information may be aggregated. For example, by considering a longer temporal context, system 500 can better capture the dynamics of moving objects and their interactions with the environment. Motion consistency can also be measured across multiple frames and/or multiple point clouds (e.g., rather than just across consecutive frames and consecutive point clouds). This can be achieved by extending the motion consistency equation to include multiple timestamps:

$$\frac{\vert {C}_{k + n} - {C}_{k} \vert}{\vert {C}_{k} - {C}_{k - n} \vert} \leq α \frac{\vert {L}_{k + n} - {L}_{k} \vert}{\vert {L}_{k} - {L}_{k - n} \vert} = \frac{\vert {odom}_{k}^{k + n} \vert}{\vert {odom}_{k - n}^{k} \vert} \qquad EQUATION 2$$

where, ‘n’ represents the number of frames to consider in the temporal context. By using a larger value of ‘n’, system 500 can better capture the motion patterns and distinguish moving objects from static ones. Accordingly, in some aspects, loss calculator 614 may train system 500 based on losses calculated based on multiple sets of training images 606, training point clouds 608, and corresponding training odometry data 610.

To use motion consistency, an odometry-consistency loss can be defined. Let Zₖ represent either Lₖ or Cₖ, indicating the input modality at time k. The loss equation is as follows:

$$\vert {odom}_{k}^{k + 1} \vert \cdot \vert {Z}_{k} - {Z}_{k - 1} \vert = \vert {odom}_{k - 1}^{k} \vert \cdot \vert {Z}_{k + 1} - {Z}_{k} \vert \qquad EQUATION 3$$

The objective of the odometry-consistency loss may be to enforce the product of the odometry magnitude and the difference between consecutive inputs to be consistent across frames. Since static objects “move” consistently relative to the ego vehicle, system 500, having been trained by trainer 602 according to the odometry-consistency loss may identify moving objects as outliers.

For example, loss calculator 614 may implement an odometry-consistency loss function. For example, loss calculator 614 may calculate a loss based on Equation 3 (or Equation 3 as modified by the principles of Equation 2, such as, by using n instead of 1). For instance, loss calculator 614 may take three instance of image features determined by system 200 and compare the magnitude of the motion between the images to the magnitude of motion of an ego system or device. For example, loss calculator 614 may calculate Zₖ-Zₖ₋₁ based on BEV image features 210 and BEV image features 220 and calculate Zₖ+₁-Zₖ based on BEV image features 230 and BEV image features 220. Further, loss calculator 614 may calculate odomₖ^{k+1} and odomₖ₋₁^{k} based on training odometry data 610 and determine a loss-based Equation 3. Trainer 602 may adjust system 500 (e.g., by adjusting weights of machine-learning models of system 200, system 300, and/or system 400a) based on the loss. As another example, loss calculator 614 may take three instance of point-cloud features determined by system 300 and compare the magnitude of the motion between the point clouds to the magnitude of motion of an ego system or device. For example, loss calculator 614 may calculate Zₖ-Zₖ₋₁ based on BEV point-cloud features 310 and BEV point-cloud features 320 and calculate Zₖ₊₁-Zₖ based on BEV point-cloud features 330 and BEV point-cloud features 320. Further, loss calculator 614 may calculate odomₖ^{k+1} and odomₖ₋₁^{k} based on training odometry data 610 and determine a loss-based Equation 3. Trainer 602 may adjust system 500 (e.g., by adjusting weights of machine-learning models of system 200, system 300, and/or system 400a) based on the loss.

In some aspects, loss calculator 614 may use semantic information when considering image-data features and/or point-cloud-data features. For example, instead of considering motion consistency for all pixels of images representing a scene or all points of a point cloud representation of the scene, loss calculator 614 may use semantic information to consider objects with certain semantic labels. In this way, loss calculator 614 may use semantic information to enhance the accuracy of system 500 in generating classified scene data 612. By leveraging semantic segmentation networks, system 600 can focus on specific classes of objects (non-movable classes such as sidewalks and buildings) and enforce motion consistency for those classes. This can be achieved by obtaining a semantic segmentation map including semantic labels assigned to each pixel or point and incorporating them into the motion consistency equation. In some aspects, the systems and techniques may determine the semantic segmentation map (e.g., using a pre-trained segmentation network). For example, system 500, system 600, or another system external to both system 500 and system 600 may include a semantic labeler that may label pixel of training image 606 and/or points of training point cloud 608. The semantic labeler may label pixels and/or points with labels such as car, pedestrian, tree, building, etc. Loss calculator 614 receive the labels corresponding to the image-data features (e.g., BEV image features 210, BEV image features 220, and/or BEV image features 230) and the point-cloud-data features (e.g., BEV point-cloud features 310, BEV point-cloud features 320, and/or BEV point-cloud features 330). Loss calculator 614 may apply the loss, for example, as described by Equation 3, to pixels of the image-data features and/or to points of the point-cloud-data features based on the semantic labels.

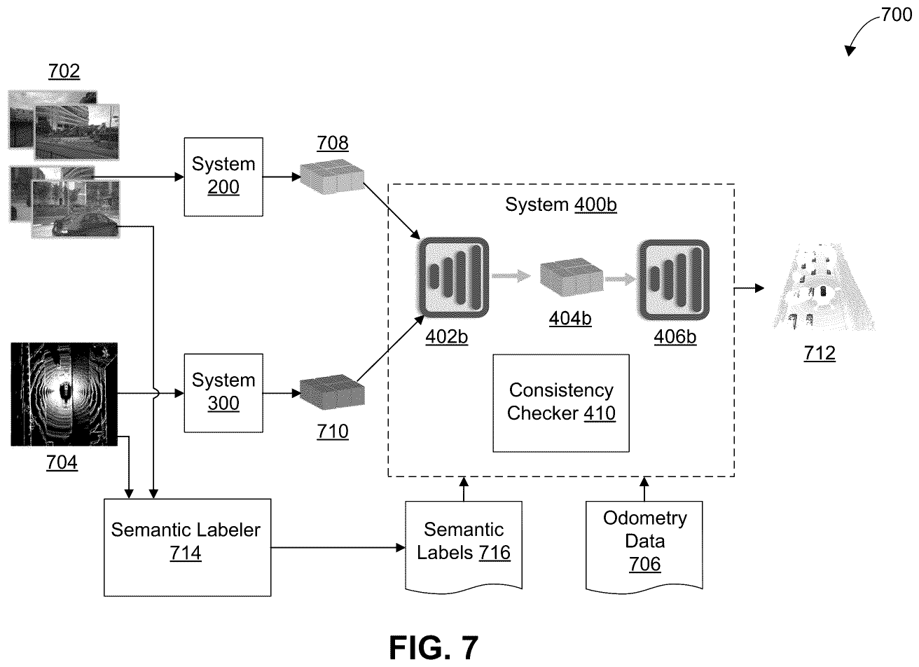

FIG. 7 is a block diagram illustrating an example system 700 that may detect moving objects according to various aspects of the present disclosure. System 700 may include system 200 of FIG. 2, system 300 of FIG. 3, and system 400b, which is similar to system 400a of FIG. 4. System 200 may generate BEV image features 708 based on images 702 in the same way that system 200 generates BEV image features 224 based on images 202 and images 212. System 300 may generate BEV point-cloud features 710 in the same way that system 300 generates BEV point-cloud features 324 based on point cloud 302 and point cloud 312.

System 400b may generate classified scene data 712 based on BEV image features 708, BEV point-cloud features 710, and odometry data 706 in a way that is similar to the way that system 400a of FIG. 4 generates classified scene data 408 based on BEV image features 224 and BEV point-cloud features 324. However, system 400b may incorporate odometry data 706 into the moving-object detection. For example, system 400b may take odometry data 706 (which may include 6DoF pose data) as input and integrate odometry data 706 with BEV image features 708 and/or BEV point-cloud features 710.

For example, in some aspects, attention network 402b may generate fused features 404b based on BEV image features 708 and BEV point-cloud features 710 in the same way that attention network 402a generates fused features 404a based on BEV image features 224 and BEV point-cloud features 324. Further, classifier 406b may generate classified scene data 712 based on fused features 404b and odometry data 706. For example, classifier 406b may be trained to generate classified scene data based on fused features and odometry data. As another example, in some aspects, attention network 402b may generate fused features 404b based on BEV image features 708, BEV point-cloud features 710, and odometry data 706. For example, attention network 402b may be trained to generate fused features based on BEV image features, BEV point-cloud features, and odometry data. Further classifier 406b may generate classified scene data 712 based on fused features 404b.

System 700 may apply motion consistency and/or magnitude-of-motion comparisons to generate classified scene data 712. For example, the machine-learning models of system 400b (e.g., attention network 402b and/or classifier 406b) may be trained to use odometry data 706 at inference based on motion consistency and/or magnitude-of-motion comparisons.

Additionally or alternatively, system 400b may include a consistency checker 410 that may determine motion consistency between consecutive frames and/or point clouds using odometry cues. For example, consistency checker 410 may compare the motion of objects in the scene (e.g., as represented in BEV image features 708 and/or BEV point-cloud features 710) with the expected motion based on the odometry data 706. Consistency checker 410 may determine that objects that exhibit motion that is inconsistent with odometry data 706 are moving.

Additionally or alternatively, consistency checker 410 may detecting outliers based on a motion consistency analysis. For example, consistency checker 410 may identify pixels, points, or voxels that exhibit significantly different velocities compared to the expected motion derived from the odometry cues. Consistency checker 410 may determine that pixels, points, or voxels that exhibit motion that is different from motion described by odometry data 706 are moving.

In some aspects, system 400b may use semantic information when considering image-data features and/or point-cloud-data features. For example, instead of considering motion consistency for all pixels of images representing a scene or all points of a point cloud representation of the scene, system 400b may use semantic labels 716 to consider objects with certain semantic labels. In this way, system 400b may use semantic information to enhance the accuracy of system 400b in generating classified scene data 712. By leveraging semantic segmentation networks, system 400b can focus on specific classes of objects (non-movable classes such as sidewalks and buildings) and enforce motion consistency only for those classes. This can be achieved by assigning semantic labels to each pixel or point and incorporating them into the motion consistency equation. For example, system 400b may include a semantic labeler, or system 700 may include semantic labeler 714. Either the semantic labeler of system 400b or semantic labeler 714 may label pixel of images 702 and/or points of point clouds 704 with labels such as car, pedestrian, tree, building, etc. System 400b may receive the semantic labels 716 corresponding to the images 702 and/or point clouds 704 from semantic labeler 714 or from its internal semantic labeler. System 400b may check the motion consistency of pixels of the images 702 and/or of points of point clouds 704 based on the semantic labels.

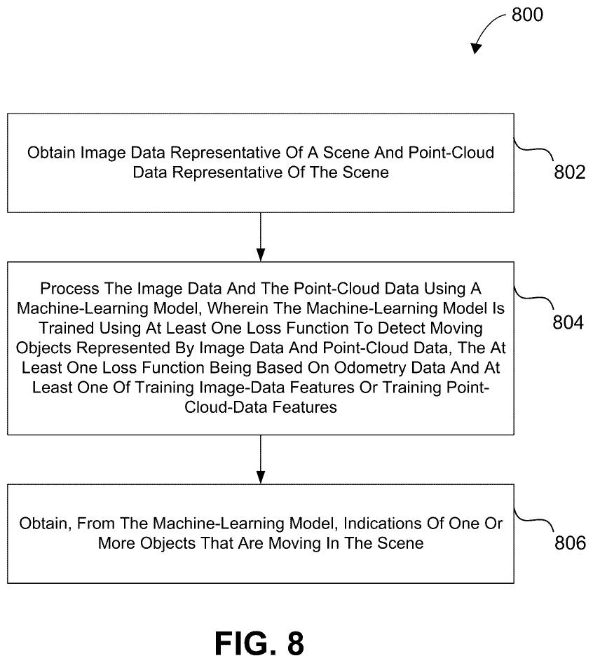

FIG. 8 is a flow diagram illustrating a process 800 for detecting moving objects, in accordance with aspects of the present disclosure. One or more operations of process 800 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 800. The one or more operations of process 800 may be implemented as software components that are executed and run on one or more processors.

At block 802, a computing device (or one or more components thereof) may obtain image data representative of a scene and point-cloud data representative of the scene. For example, system 200 of FIG. 2, FIG. 4, and/or FIG. 5 may obtain images 202, images 212, and/or images 502 and/or system 300 of FIG. 3, FIG. 4, and/or FIG. 5 may obtain point cloud 302, point cloud 312 and/or point cloud 504.

At block 804, the computing device (or one or more components thereof) may process the image data and the point-cloud data using a machine-learning model, wherein the machine-learning model is trained using at least one loss function to detect moving objects represented by image data and point-cloud data, the at least one loss function being based on odometry data and at least one of training image-data features or training point-cloud-data features. For example, system 200 of FIG. 2, FIG. 4, and/or FIG. 5 may process the images to generate BEV image features 224 and/or BEV image features 506 and system 300 of FIG. 3, FIG. 4, and/or FIG. 5 may process the point cloud to generate BEV point-cloud features 324 and/or BEV point-cloud features 508. Further, system 400a of FIG. 4 and/or FIG. 5 may process the BEV image features and the BEV point-cloud features. System 400a may be trained using at least one loss function, as described with regard to FIG. 6, (e.g., the loss function applied at loss calculator 614 of FIG. 6) based on odometry data (e.g., training odometry data 610 of FIG. 6) and training image-data features (e.g., based on training images 606 of FIG. 6) and/or training point-cloud-data features (e.g., based on training point cloud 608 of FIG. 6).

In some aspects, the at least one loss function may be based on a relationship between a change in a position of a system as indicated by the odometry data and at least one of: a change between a first set of training image-data features and a second set of training image-data features; or a change between a first set of training point-cloud-data features and a second set of training point-cloud-data features. For example, the loss function, applied at loss calculator 614 of FIG. 6, may be based on equation 1, equation 2, and/or equation 3. In some aspects, the odometry data corresponds to at least one of the training image-data features or the training point-cloud-data features.

In some aspects, the at least one loss function may be based on a relationship between a magnitude of a change in a position of a system as indicated by the odometry data and at least one of: a magnitude of a change between a first set of training image-data features and a second set of training image-data features; or a magnitude of a change between a first set of training point-cloud-data features and a second set of training point-cloud-data features. For example, the loss function, applied at loss calculator 614 of FIG. 6, may be based on equation 1, equation 2, and/or equation 3.

In some aspects, the at least one loss function may be based on a relationship between: a product of a magnitude of a first change in a position of a system as indicated by the odometry data and at least one of: a magnitude of a change between a first set of training image-data features and a second set of training image-data features; or a magnitude of a change between a first set of training point-cloud-data features and a second set of training point-cloud-data features; and a product of a magnitude of a second change in the position of the system as indicated by the odometry data and at least one of: a magnitude of a change between the second set of training image-data features and a third set of training image-data features; or a magnitude of a change between the second set of training point-cloud-data features and a third set of training point-cloud-data features. For example, the loss function, applied at loss calculator 614 of FIG. 6, may be based on equation 1, equation 2, and/or equation 3.

In some aspects, the at least one loss function may further be based on an adaptive motion-consistency threshold. For example, the loss function, applied at loss calculator 614 of FIG. 6, may be based on equation 1, equation 2, and/or equation 3 including a.

In some aspects, the adaptive motion-consistency threshold may be dynamically adjusted based on at least one of: a complexity of the scene or an uncertainty of the odometry data. For example, the loss function, applied at loss calculator 614 of FIG. 6, may be based on equation 1, equation 2, and/or equation 3 including a. Further, a may be adjusted based on a complexity of the scene and/or an uncertainty of the odometry data.

At block 806, the computing device (or one or more components thereof) may obtain, from the machine-learning model, indications of one or more objects that are moving in the scene. For example, system 400a of FIG. 4 and/or FIG. 5 may generate classified scene data 408 and/or classified scene data 510.

In some aspects, the indications of objects that are moving in the scene comprise classifications of points in the scene into classes comprising: stationary; movable; or moving. For example, system 400a may classify objects in the scene as one of stationary, movable, or moving.

In some aspects, the computing device (or one or more components thereof) may obtain classifications of objects in the scene; and provide the classifications of the objects to the machine-learning model as an input, wherein the machine-learning model is trained identify moving objects represented by image data and point-cloud data further based on classifications. For example, system 700 of FIG. 7 may obtain semantic labels 716 and provide semantic labels 716 to system 400b. System 400b may be trained to generate classified scene data 712 based on training classifications.

In some aspects, the machine-learning model may be trained identify moving objects represented by image data and point-cloud data further based on classifications of objects in the scene. For example, system 400a of FIG. 4 and/or FIG. 5 may be trained using semantic labels (e.g., object classifications. System 400a may be trained using semantic labels even if system 400a is not provided with semantic labels at inference. Additionally or alternatively, system 400b of FIG. 7 may be trained using semantic labels and may operate, at inference, using semantic labels 716.

In some aspects, the machine-learning model may be a first machine-learning model and the computing device (or one or more components thereof) may provide at least one of the image data or the point-cloud data to a second machine-learning model that is trained classify objects represented by at least one of image data or point-cloud data; and obtain the classifications of the objects from the second machine-learning model. For example, system 700 of FIG. 7 may provide images 702 and point clouds 704 to semantic labeler 714 and semantic labeler 714 may generate semantic labels 716.

In some aspects, the computing device (or one or more components thereof) may control a vehicle based on the indications of objects that are moving in the scene and/or provide information to a driver of the vehicle based on the indications of objects that are moving in the scene. For example, the computing device (or one or more components thereof) may be part of an advanced driver assistance system (ADAS) and may be capable of providing information to a driver, assisting the driver, and/or controlling the vehicle.

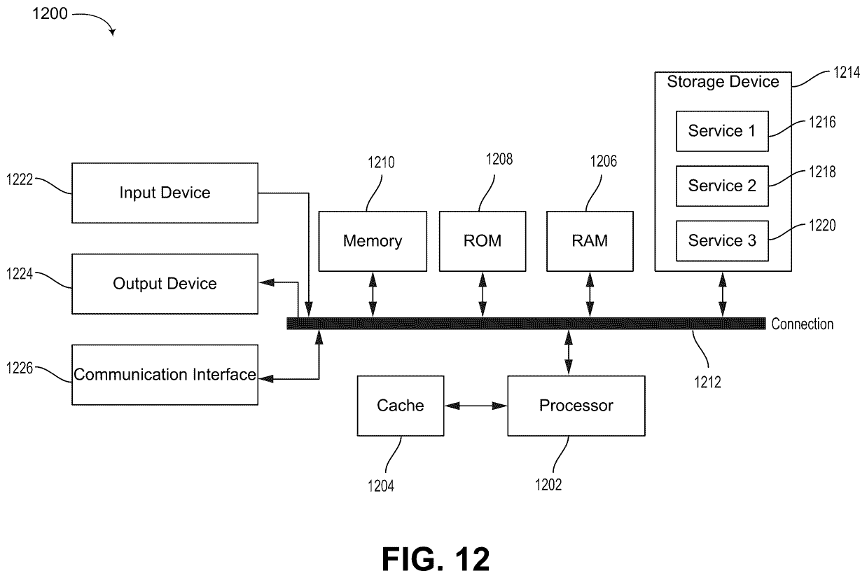

In some examples, as noted previously, the methods described herein (e.g., process 800 of FIG. 8, and/or other methods described herein) can be performed, in whole or in part, by a computing device or apparatus. In one example, one or more of the methods can be performed by system 500 of FIG. 5, system 700 of FIG. 7 or by another system or device. In another example, one or more of the methods (e.g., process 800 of FIG. 8, and/or other methods described herein) can be performed, in whole or in part, by the computing-device architecture 1200 shown in FIG. 12. For instance, a computing device with the computing-device architecture 1200 shown in FIG. 12 can include, or be included in, the components of the system 500 and/or system 700 and can implement the operations of process 800, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 800, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 800, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

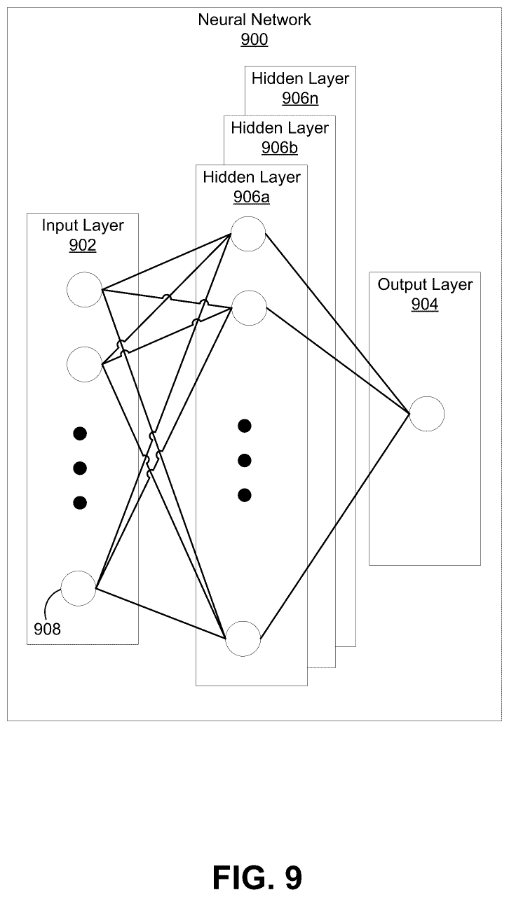

FIG. 9 is an illustrative example of a neural network 900 (e.g., a deep-learning neural network) that can be used to implement machine-learning based feature extraction, feature segmentation, implicit-neural-representation generation, rendering, classification, object detection, image recognition (e.g., face recognition, object recognition, scene recognition, etc.), authentication, gaze detection, gaze prediction, and/or automation. For example, neural network 900 may be an example of, or can implement, feature extractor 204 of FIG. 2, feature extractor 214 of FIG. 2, feature extractor 304 of FIG. 3, feature extractor 314 of FIG. 3, classifier 406a of FIG. 4, classifier 406b of FIG. 7.

An input layer 902 includes input data. In one illustrative example, input layer 902 can include data representing images 202 of FIG. 2, images 212 of FIG. 2, point cloud 302 of FIG. 3, point cloud 312 of FIG. 3, fused features 404a of FIG. 4, and/or fused features 404b of FIG. 7. Neural network 900 includes multiple hidden layers hidden layers 906a, 906b, through 906n. The hidden layers 906a, 906b, through hidden layer 906n include “n” number of hidden layers, where “n” is an integer greater than or equal to one. The number of hidden layers can be made to include as many layers as needed for the given application. Neural network 900 further includes an output layer 904 that provides an output resulting from the processing performed by the hidden layers 906a, 906b, through 906n. In one illustrative example, output layer 904 can provide image features 206 of FIG. 2, image features 216 of FIG. 2, point-cloud features 306 of FIG. 3, point-cloud features 316 of FIG. 3, classified scene data 408 of FIG. 4, and/or classified scene data 712 of FIG. 7.

Neural network 900 may be, or may include, a multi-layer neural network of interconnected nodes. Each node can represent a piece of information. Information associated with the nodes is shared among the different layers and each layer retains information as information is processed. In some cases, neural network 900 can include a feed-forward network, in which case there are no feedback connections where outputs of the network are fed back into itself. In some cases, neural network 900 can include a recurrent neural network, which can have loops that allow information to be carried across nodes while reading in input.

Information can be exchanged between nodes through node-to-node interconnections between the various layers. Nodes of input layer 902 can activate a set of nodes in the first hidden layer 906a. For example, as shown, each of the input nodes of input layer 902 is connected to each of the nodes of the first hidden layer 906a. The nodes of first hidden layer 906a can transform the information of each input node by applying activation functions to the input node information. The information derived from the transformation can then be passed to and can activate the nodes of the next hidden layer 906b, which can perform their own designated functions. Example functions include convolutional, up-sampling, data transformation, and/or any other suitable functions. The output of the hidden layer 906b can then activate nodes of the next hidden layer, and so on. The output of the last hidden layer 906n can activate one or more nodes of the output layer 904, at which an output is provided. In some cases, while nodes (e.g., node 908) in neural network 900 are shown as having multiple output lines, a node has a single output and all lines shown as being output from a node represent the same output value.

In some cases, each node or interconnection between nodes can have a weight that is a set of parameters derived from the training of neural network 900. Once neural network 900 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 900 to be adaptive to inputs and able to learn as more and more data is processed.

Neural network 900 may be pre-trained to process the features from the data in the input layer 902 using the different hidden layers 906a, 906b, through 906n in order to provide the output through the output layer 904. In an example in which neural network 900 is used to identify features in images, neural network 900 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 900 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 900 is trained well enough so that the weights of the layers are accurately tuned.

For the example of identifying objects in images, the forward pass can include passing a training image through neural network 900. The weights are initially randomized before neural network 900 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 900, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 900 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½(target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 900 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wᵢ denotes the initial weight, and f denotes a learning rate. The learning rate can be set to any suitable value, with a high learning rate including larger weight updates and a lower value indicating smaller weight updates.

Neural network 900 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 900 can include any other deep network other than a CNN, such as an autoencoder, a deep belief nets (DBNs), a Recurrent Neural Networks (RNNs), among others.

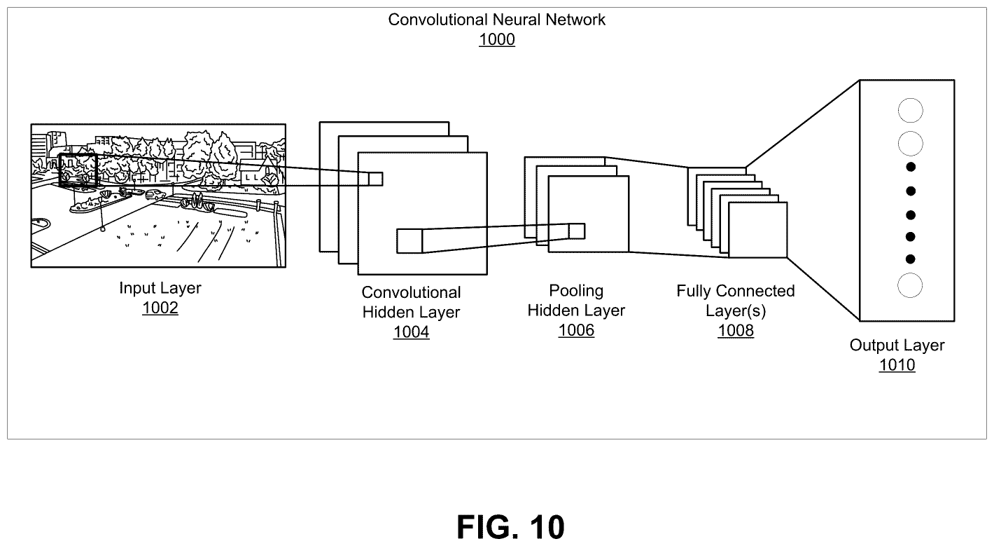

FIG. 10 is an illustrative example of a convolutional neural network (CNN) 1000. The input layer 1002 of the CNN 1000 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1004, an optional non-linear activation layer, a pooling hidden layer 1006, and fully connected layer 1008 (which fully connected layer 1008 can be hidden) to get an output at the output layer 1010. While only one of each hidden layer is shown in FIG. 10, one of ordinary skill will appreciate that multiple convolutional hidden layers, non-linear layers, pooling hidden layers, and/or fully connected layers can be included in the CNN 1000. As previously described, the output can indicate a single class of an object or can include a probability of classes that best describe the object in the image.

The first layer of the CNN 1000 can be the convolutional hidden layer 1004. The convolutional hidden layer 1004 can analyze image data of the input layer 1002. Each node of the convolutional hidden layer 1004 is connected to a region of nodes (pixels) of the input image called a receptive field. The convolutional hidden layer 1004 can be considered as one or more filters (each filter corresponding to a different activation or feature map), with each convolutional iteration of a filter being a node or neuron of the convolutional hidden layer 1004. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1004. Each connection between a node and a receptive field for that node learns a weight and, in some cases, an overall bias such that each node learns to analyze its particular local receptive field in the input image. Each node of the convolutional hidden layer 1004 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1004 is due to each node of the convolutional layer being applied to its corresponding receptive field. For example, a filter of the convolutional hidden layer 1004 can begin in the top-left corner of the input image array and can convolve around the input image. As noted above, each convolutional iteration of the filter can be considered a node or neuron of the convolutional hidden layer 1004. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1004. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1004.

The mapping from the input layer to the convolutional hidden layer 1004 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1004 can include several activation maps in order to identify multiple features in an image. The example shown in FIG. 10 includes three activation maps. Using three activation maps, the convolutional hidden layer 1004 can detect three different kinds of features, with each feature being detectable across the entire image.

In some examples, a non-linear hidden layer can be applied after the convolutional hidden layer 1004. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1000 without affecting the receptive fields of the convolutional hidden layer 1004.

The pooling hidden layer 1006 can be applied after the convolutional hidden layer 1004 (and after the non-linear hidden layer when used). The pooling hidden layer 1006 is used to simplify the information in the output from the convolutional hidden layer 1004. For example, the pooling hidden layer 1006 can take each activation map output from the convolutional hidden layer 1004 and generates a condensed activation map (or feature map) using a pooling function. Max-pooling is one example of a function performed by a pooling hidden layer. Other forms of pooling functions be used by the pooling hidden layer 1006, such as average pooling, L2-norm pooling, or other suitable pooling functions. A pooling function (e.g., a max-pooling filter, an L2-norm filter, or other suitable pooling filter) is applied to each activation map included in the convolutional hidden layer 1004. In the example shown in FIG. 10, three pooling filters are used for the three activation maps in the convolutional hidden layer 1004.

In some examples, max-pooling can be used by applying a max-pooling filter (e.g., having a size of 2×2) with a stride (e.g., equal to a dimension of the filter, such as a stride of 2) to an activation map output from the convolutional hidden layer 1004. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1004 having a dimension of 24×24 nodes, the output from the pooling hidden layer 1006 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1000.

The final layer of connections in the network is a fully-connected layer that connects every node from the pooling hidden layer 1006 to every one of the output nodes in the output layer 1010. Using the example above, the input layer includes 28×28 nodes encoding the pixel intensities of the input image, the convolutional hidden layer 1004 includes 3×24×24 hidden feature nodes based on application of a 5×5 local receptive field (for the filters) to three activation maps, and the pooling hidden layer 1006 includes a layer of 3×12×12 hidden feature nodes based on application of max-pooling filter to 2×2 regions across each of the three feature maps. Extending this example, the output layer 1010 can include ten output nodes. In such an example, every node of the 3×12×12 pooling hidden layer 1006 is connected to every node of the output layer 1010.

The fully connected layer 1008 can obtain the output of the previous pooling hidden layer 1006 (which should represent the activation maps of high-level features) and determines the features that most correlate to a particular class. For example, the fully connected layer 1008 can determine the high-level features that most strongly correlate to a particular class and can include weights (nodes) for the high-level features. A product can be computed between the weights of the fully connected layer 1008 and the pooling hidden layer 1006 to obtain probabilities for the different classes. For example, if the CNN 1000 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1010 can include an M-dimensional vector (in the prior example, M=10). M indicates the number of classes that the CNN 1000 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

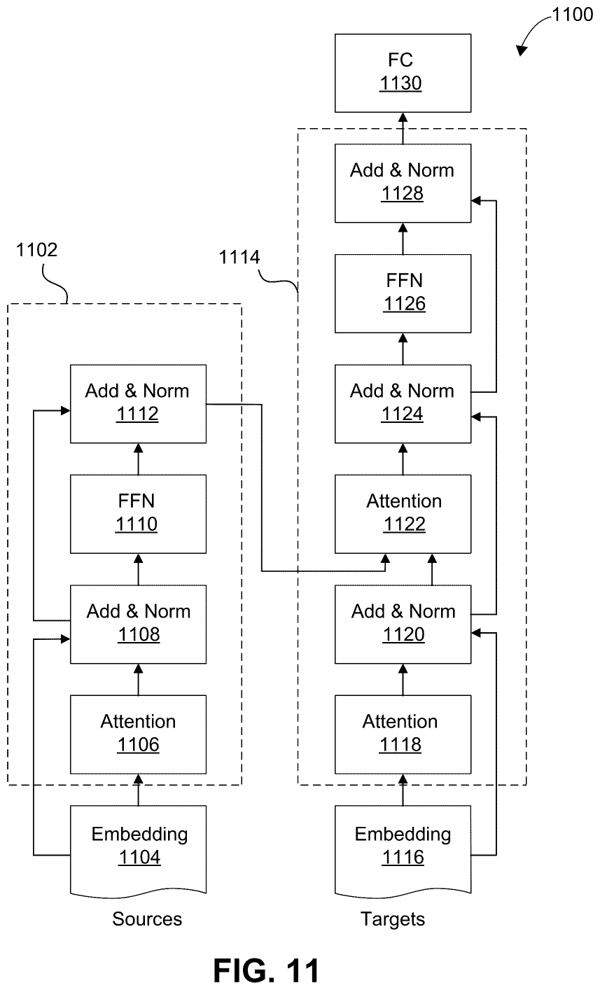

FIG. 11 is a block diagram of an example transformer 1100 that may be used to perform various operations described herein, according to various aspects of the present disclosure. For example, transformer 1100 may be an example of any of all of attention network 222 of FIG. 2, attention network 322 of FIG. 3, attention network 402a of FIG. 4, and/or classifier 406b of FIG. 7. Transformer 1100 may include encoder 1102 and decoder 1114.

Encoder 1102 may obtain embedding 1104. Embedding 1104 may be an example of any of all of BEV image features 210 of FIG. 2, BEV point-cloud features 310 of FIG. 3, BEV image features 224 of FIG. 4, BEV point-cloud features 324 of FIG. 4, BEV image features 708 of FIG. 7, and/or BEV point-cloud features 710 of FIG. 7. Encoder 1102 may apply multi-head attention to embedding 1104 at attention block 1106. At combiner and normalizer 1108, encoder 1102 may combine and normalize the output of attention block 1106 and embedding 1104. At position-wise feed-forward network (FFN) 1110, encoder 1102 may adjust the output of combiner and normalizer 1108 to be more suitable for use in decoder 1114. At combiner and normalizer 1112, encoder 1102 may combine and normalize the outputs of combiner and normalizer 1108 and position-wise FFN 1110.

Decoder 1114 may obtain embedding 1116. Embedding 1116 may be an example of any or all of BEV image features 220 of FIG. 2, BEV point-cloud features 320 of FIG. 3, BEV image features 224 of FIG. 4, BEV point-cloud features 324 of FIG. 4, BEV image features 708 of FIG. 7, and/or BEV point-cloud features 710 of FIG. 7. At attention block 1118, decoder 1114 may apply multi-head attention to embedding 1116. At combiner and normalizer 1120, decoder 1114 may combine and normalize the output of attention block 1118 and embedding 1116. At attention block 1122, decoder 1114 may apply multi-head attention to the output of combiner and normalizer 1120. Attention block 1122 may use an output of encoder 1102 (e.g., an output of combiner and normalizer 1112) as a query when processing the output of combiner and normalizer 1120. At combiner and normalizer 1124, decoder 1114 may combine and normalize the output of attention block 1122 and combiner and normalizer 1120. At position-wise FFN 1126, decoder 1114 may adjust the output of combiner and normalizer 1124 to be more suitable to be output by decoder 1114. At combiner and normalizer 1128, decoder 1114 may combine and normalize the outputs of combiner and normalizer 1124 and position-wise FFN 1126. Fully connected layers (FC) 1130 may process the output of combiner and normalizer 1128.

Encoder 1102 is illustrated and described as including one attention block 1106. In practice, encoder 1102 may include any number of attention blocks 1106 and/or any number of corresponding combiner and normalizers 1108, position-wise FFNs 1110, and/or combiner and normalizers 1112. Similarly, decoder 1114 is illustrated and described as including one attention block 1118 and one attention block 1122. In practice, decoder 1114 may include any number of attention blocks 1118 and attention blocks 1122 and/or any number of corresponding combiner and normalizers 1120, combiner and normalizers 1124, position-wise FFNs 1126, and/or combiner and normalizers 1128.

FIG. 12 illustrates an example computing-device architecture 1200 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1200 may include, implement, or be included in any or all of system 200 of FIG. 2, system 300 of FIG. 3, system 400a of FIG. 4, system 500 of FIG. 5, system 600 of FIG. 6, and/or system 700 of FIG. 7. Additionally or alternatively, computing-device architecture 1200 may be configured to perform process 800, and/or other process described herein.

The components of computing-device architecture 1200 are shown in electrical communication with each other using connection 1212, such as a bus. The example computing-device architecture 1200 includes a processing unit (CPU or processor) 1202 and computing device connection 1212 that couples various computing device components including computing device memory 1210, such as read only memory (ROM) 1208 and random-access memory (RAM) 1206, to processor 1202.

Computing-device architecture 1200 can include a cache of high-speed memory connected directly with, in close proximity to, or integrated as part of processor 1202. Computing-device architecture 1200 can copy data from memory 1210 and/or the storage device 1214 to cache 1204 for quick access by processor 1202. In this way, the cache can provide a performance boost that avoids processor 1202 delays while waiting for data. These and other modules can control or be configured to control processor 1202 to perform various actions. Other computing device memory 1210 may be available for use as well. Memory 1210 can include multiple different types of memory with different performance characteristics. Processor 1202 can include any general-purpose processor and a hardware or software service, such as service 1 1216, service 2 1218, and service 3 1220 stored in storage device 1214, configured to control processor 1202 as well as a special-purpose processor where software instructions are incorporated into the processor design. Processor 1202 may be a self-contained system, containing multiple cores or processors, a bus, memory controller, cache, etc. A multi-core processor may be symmetric or asymmetric.

To enable user interaction with the computing-device architecture 1200, input device 1222 can represent any number of input mechanisms, such as a microphone for speech, a touch-sensitive screen for gesture or graphical input, keyboard, mouse, motion input, speech and so forth. Output device 1224 can also be one or more of a number of output mechanisms known to those of skill in the art, such as a display, projector, television, speaker device, etc. In some instances, multimodal computing devices can enable a user to provide multiple types of input to communicate with computing-device architecture 1200. Communication interface 1226 can generally govern and manage the user input and computing device output. There is no restriction on operating on any particular hardware arrangement and therefore the basic features here may easily be substituted for improved hardware or firmware arrangements as they are developed.

Storage device 1214 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1206, read only memory (ROM) 1208, and hybrids thereof. Storage device 1214 can include services 1216, 1218, and 1220 for controlling processor 1202. Other hardware or software modules are contemplated. Storage device 1214 can be connected to the computing device connection 1212. In one aspect, a hardware module that performs a particular function can include the software component stored in a computer-readable medium in connection with the necessary hardware components, such as processor 1202, connection 1212, output device 1224, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

### Illustrative Aspects of the Disclosure Include:

Aspect 1. An apparatus for detecting objects, the apparatus comprising: at least one memory; and at least one processor coupled to the at least one memory and configured to: obtain image data representative of a scene and point-cloud data representative of the scene; process the image data and the point-cloud data using a machine-learning model, wherein the machine-learning model is trained using at least one loss function to detect moving objects represented by image data and point-cloud data, the at least one loss function being based on odometry data and at least one of training image-data features or training point-cloud-data features; and obtain, from the machine-learning model, indications of one or more objects that are moving in the scene.

Aspect 2. The apparatus of aspect 1, wherein the at least one loss function is based on a relationship between a change in a position of a system as indicated by the odometry data and at least one of: a change between a first set of training image-data features and a second set of training image-data features; or a change between a first set of training point-cloud-data features and a second set of training point-cloud-data features.

Aspect 3. The apparatus of aspect 2, wherein the odometry data corresponds to at least one of the training image-data features or the training point-cloud-data features.

Aspect 4. The apparatus of any one of aspects 1 to 3, wherein the at least one loss function is based on a relationship between a magnitude of a change in a position of a system as indicated by the odometry data and at least one of: a magnitude of a change between a first set of training image-data features and a second set of training image-data features; or a magnitude of a change between a first set of training point-cloud-data features and a second set of training point-cloud-data features.

Aspect 5. The apparatus of any one of aspects 1 to 4, wherein the at least one loss function is based on a relationship between: a product of a magnitude of a first change in a position of a system as indicated by the odometry data and at least one of: a magnitude of a change between a first set of training image-data features and a second set of training image-data features; or a magnitude of a change between a first set of training point-cloud-data features and a second set of training point-cloud-data features; and a product of a magnitude of a second change in the position of the system as indicated by the odometry data and at least one of: a magnitude of a change between the second set of training image-data features and a third set of training image-data features; or a magnitude of a change between the second set of training point-cloud-data features and a third set of training point-cloud-data features.

Aspect 6. The apparatus of any one of aspects 1 to 5, where the at least one processor is further configured to: obtain classifications of objects in the scene; and provide the classifications of the objects to the machine-learning model as an input, wherein the machine-learning model is trained identify moving objects represented by image data and point-cloud data further based on classifications.

Aspect 7. The apparatus of aspect 6, wherein the machine-learning model comprises a first machine-learning model and the at least one processor is further configured to: provide at least one of the image data or the point-cloud data to a second machine-learning model that is trained classify objects represented by at least one of image data or point-cloud data; and obtain the classifications of the objects from the second machine-learning model.

Aspect 8. The apparatus of any one of aspects 1 to 7, wherein the machine-learning model is trained identify moving objects represented by image data and point-cloud data further based on classifications of objects in the scene.

Aspect 9. The apparatus of any one of aspects 1 to 8, wherein the at least one loss function is further based on an adaptive motion-consistency threshold.

Aspect 10. The apparatus of aspect 9, wherein the adaptive motion-consistency threshold is dynamically adjusted based on at least one of: a complexity of the scene or an uncertainty of the odometry data.

Aspect 11. The apparatus of any one of aspects 1 to 10, wherein the indications of objects that are moving in the scene comprise classifications of points in the scene into classes comprising: stationary; movable; or moving.

Aspect 12. The apparatus of any one of aspects 1 to 11, wherein the at least one processor is further configured to at least one of: control a vehicle based on the indications of objects that are moving in the scene; or provide information to a driver of the vehicle based on the indications of objects that are moving in the scene.

Aspect 13. A method for detecting objects, the method comprising: obtaining image data representative of a scene and point-cloud data representative of the scene; processing the image data and the point-cloud data using a machine-learning model, wherein the machine-learning model is trained using at least one loss function to detect moving objects represented by image data and point-cloud data, the at least one loss function being based on odometry data and at least one of training image-data features or training point-cloud-data features; and obtaining, from the machine-learning model, indications of one or more objects that are moving in the scene.

Aspect 14. The method of aspect 13, wherein the at least one loss function is based on a relationship between a change in a position of a system as indicated by the odometry data and at least one of: a change between a first set of training image-data features and a second set of training image-data features; or a change between a first set of training point-cloud-data features and a second set of training point-cloud-data features.

Aspect 15. The method of aspect 14, wherein the odometry data corresponds to at least one of the training image-data features or the training point-cloud-data features.

Aspect 16. The method of any one of aspects 13 to 15, wherein the at least one loss function is based on a relationship between a magnitude of a change in a position of a system as indicated by the odometry data and at least one of: a magnitude of a change between a first set of training image-data features and a second set of training image-data features; or a magnitude of a change between a first set of training point-cloud-data features and a second set of training point-cloud-data features.

Aspect 17. The method of any one of aspects 13 to 16, wherein the at least one loss function is based on a relationship between: a product of a magnitude of a first change in a position of a system as indicated by the odometry data and at least one of: a magnitude of a change between a first set of training image-data features and a second set of training image-data features; or a magnitude of a change between a first set of training point-cloud-data features and a second set of training point-cloud-data features; and a product of a magnitude of a second change in the position of the system as indicated by the odometry data and at least one of: a magnitude of a change between the second set of training image-data features and a third set of training image-data features; or a magnitude of a change between the second set of training point-cloud-data features and a third set of training point-cloud-data features.

Aspect 18. The method of any one of aspects 13 to 17, further comprising: obtaining classifications of objects in the scene; and providing the classifications of the objects to the machine-learning model as an input, wherein the machine-learning model is trained identify moving objects represented by image data and point-cloud data further based on classifications.

Aspect 19. The method of aspect 18, wherein the machine-learning model comprises a first machine-learning model and further comprising: providing at least one of the image data or the point-cloud data to a second machine-learning model that is trained classify objects represented by at least one of image data or point-cloud data; and obtaining the classifications of the objects from the second machine-learning model.

Aspect 20. The method of any one of aspects 13 to 19, wherein the machine-learning model is trained identify moving objects represented by image data and point-cloud data further based on classifications of objects in the scene.

Aspect 21. The method of any one of aspects 13 to 20, wherein the at least one loss function is further based on an adaptive motion-consistency threshold.

Aspect 22. The method of aspect 21, wherein the adaptive motion-consistency threshold is dynamically adjusted based on at least one of: a complexity of the scene or an uncertainty of the odometry data.

Aspect 23. The method of any one of aspects 13 to 22, wherein the indications of objects that are moving in the scene comprise classifications of points in the scene into classes comprising: stationary; movable; or moving.

Aspect 24. The method of any one of aspects 13 to 23, further comprising at least one of: controlling a vehicle based on the indications of objects that are moving in the scene; or providing information to a driver of the vehicle based on the indications of objects that are moving in the scene.

Aspect 25. A non-transitory computer-readable storage medium having stored thereon instructions that, when executed by at least one processor, cause the at least one processor to perform operations according to any of aspects 13 to 24.

Aspect 26. An apparatus for providing virtual content for display, the apparatus comprising one or more means for perform operations according to any of aspects 13 to 24.

What is claimed is:

1. An apparatus for detecting objects, the apparatus comprising:
at least one memory; and
at least one processor coupled to the at least one memory and configured to:
obtain image data representative of a scene and point-cloud data representative of the scene;
process the image data and the point-cloud data using a machine-learning model, wherein the machine-learning model is trained using at least one loss function to detect moving objects represented by image data and point-cloud data, the at least one loss function being based on odometry data and at least one of training image-data features or training point-cloud-data features; and
obtain, from the machine-learning model, indications of one or more objects that are moving in the scene.

2. The apparatus of claim 1, wherein the at least one loss function is based on a relationship between a change in a position of a system as indicated by the odometry data and at least one of:
a change between a first set of training image-data features and a second set of training image-data features; or
a change between a first set of training point-cloud-data features and a second set of training point-cloud-data features.

3. The apparatus of claim 2, wherein the odometry data corresponds to at least one of the training image-data features or the training point-cloud-data features.

4. The apparatus of claim 1, wherein the at least one loss function is based on a relationship between a magnitude of a change in a position of a system as indicated by the odometry data and at least one of:
a magnitude of a change between a first set of training image-data features and a second set of training image-data features; or
a magnitude of a change between a first set of training point-cloud-data features and a second set of training point-cloud-data features.

5. The apparatus of claim 1, wherein the at least one loss function is based on a relationship between:
a product of a magnitude of a first change in a position of a system as indicated by the odometry data and at least one of:
a magnitude of a change between a first set of training image-data features and a second set of training image-data features; or
a magnitude of a change between a first set of training point-cloud-data features and a second set of training point-cloud-data features; and
a product of a magnitude of a second change in the position of the system as indicated by the odometry data and at least one of:
a magnitude of a change between the second set of training image-data features and a third set of training image-data features; or
a magnitude of a change between the second set of training point-cloud-data features and a third set of training point-cloud-data features.

6. The apparatus of claim 1, where the at least one processor is further configured to:
obtain classifications of objects in the scene; and
provide the classifications of the objects to the machine-learning model as an input, wherein the machine-learning model is trained identify moving objects represented by image data and point-cloud data further based on classifications.

7. The apparatus of claim 6, wherein the machine-learning model comprises a first machine-learning model and the at least one processor is further configured to:
provide at least one of the image data or the point-cloud data to a second machine-learning model that is trained classify objects represented by at least one of image data or point-cloud data; and
obtain the classifications of the objects from the second machine-learning model.

8. The apparatus of claim 1, wherein the machine-learning model is trained identify moving objects represented by image data and point-cloud data further based on classifications of objects in the scene.

9. The apparatus of claim 1, wherein the at least one loss function is further based on an adaptive motion-consistency threshold.

10. The apparatus of claim 9, wherein the adaptive motion-consistency threshold is dynamically adjusted based on at least one of: a complexity of the scene or an uncertainty of the odometry data.

11. The apparatus of claim 1, wherein the indications of objects that are moving in the scene comprise classifications of points in the scene into classes comprising:
stationary;
movable; or
moving.

12. The apparatus of claim 1, wherein the at least one processor is further configured to at least one of:
control a vehicle based on the indications of objects that are moving in the scene; or
provide information to a driver of the vehicle based on the indications of objects that are moving in the scene.

13. A method for detecting objects, the method comprising:
obtaining image data representative of a scene and point-cloud data representative of the scene;
processing the image data and the point-cloud data using a machine-learning model, wherein the machine-learning model is trained using at least one loss function to detect moving objects represented by image data and point-cloud data, the at least one loss function being based on odometry data and at least one of training image-data features or training point-cloud-data features; and
obtaining, from the machine-learning model, indications of one or more objects that are moving in the scene.

14. The method of claim 13, wherein the at least one loss function is based on a relationship between a change in a position of a system as indicated by the odometry data and at least one of:
a change between a first set of training image-data features and a second set of training image-data features; or
a change between a first set of training point-cloud-data features and a second set of training point-cloud-data features.

15. The method of claim 14, wherein the odometry data corresponds to at least one of the training image-data features or the training point-cloud-data features.

16. The method of claim 13, wherein the at least one loss function is based on a relationship between a magnitude of a change in a position of a system as indicated by the odometry data and at least one of:
a magnitude of a change between a first set of training image-data features and a second set of training image-data features; or
a magnitude of a change between a first set of training point-cloud-data features and a second set of training point-cloud-data features.

17. The method of claim 13, wherein the at least one loss function is based on a relationship between:
a product of a magnitude of a first change in a position of a system as indicated by the odometry data and at least one of:
a magnitude of a change between a first set of training image-data features and a second set of training image-data features; or
a magnitude of a change between a first set of training point-cloud-data features and a second set of training point-cloud-data features; and
a product of a magnitude of a second change in the position of the system as indicated by the odometry data and at least one of:
a magnitude of a change between the second set of training image-data features and a third set of training image-data features; or
a magnitude of a change between the second set of training point-cloud-data features and a third set of training point-cloud-data features.

18. The method of claim 13, further comprising:
obtaining classifications of objects in the scene; and
providing the classifications of the objects to the machine-learning model as an input, wherein the machine-learning model is trained identify moving objects represented by image data and point-cloud data further based on classifications.

19. The method of claim 18, wherein the machine-learning model comprises a first machine-learning model and further comprising:
providing at least one of the image data or the point-cloud data to a second machine-learning model that is trained classify objects represented by at least one of image data or point-cloud data; and
obtaining the classifications of the objects from the second machine-learning model.

20. The method of claim 13, wherein the machine-learning model is trained identify moving objects represented by image data and point-cloud data further based on classifications of objects in the scene.
